(19) United States
(12) Patent Application Publication
(10) Pub. No.: US 2005/0004923 A1
(43) Pub. Date: Jan. 6, 2005

(54) Community service providing system and method

(75) Inventor: Hyuncheol Park, Suwon-city (JP)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/718,576

(22) Filed: Nov. 24, 2003

(30) Foreign Application Priority Data
Jul. 2, 2003 (KR) 10-2003-0007725

(51) Int. Cl. G06F 7/00

(52) U.S. Cl. 707/100

(57) ABSTRACT

The present invention relates to a system and method for providing community services. An object of the present invention is to provide a system and method for providing community services wherein emotions or conditions of respective communication service users can be indirectly confirmed by representing information on the emotions or conditions of predetermined communication service users as coordinate values on an emotion map configured on the basis of predetermined information axes and generating predetermined events in accordance with determination results of similarities or differences between the coordinate values based on the coordinate values represented on the emotion map, and thus, opportunities to meet other community members can also be provided through the generation of suitable events.

### BACKGROUND OF THE INVENTION

This application claims the priority of Korean Patent Application No. 10-2003-0007725, filed on Feb. 7, 2003, in the Korean Intellectual Property Office, the disclosure of which is incorporated herein in its entirety by reference.

1. Field of the Invention

The present invention relates to a system and method for providing community services, and more particularly, to a system and method for providing community services wherein emotions or conditions of respective communication service users can be indirectly confirmed by representing information on the emotions or conditions of predetermined communication service users as coordinate values on an emotion map configured based on predetermined information axes, and generating predetermined events in accordance with determination results of similarities or differences between the coordinate values based on the coordinate values represented on the emotion map.

2. Description of the Related Art

Generally, the community means the spatial and regional unit as a social organization and is also used to designate psychological unity or belongingness related thereto. Recently, the community is widely known as a group that has been organized to share information or communicate with one another among specific communication service users in cyber space, also known as the Internet.

This community is constructed through a community server. The communication service users access the community server via a wired/wireless communication network with specific user devices and use community services such as information sharing, communications or the like. Among the functions provided in the form of community services, there is a function of expressing the condition of users, which allows the users in the specific community group to express their current emotions or conditions.

Generally, the function of expressing the condition of users is provided in such a manner that the users select a fixed predetermined text or icon or directly inputs limited predetermined texts.

That is, as shown in FIG. 1, if a community is constructed in a server in accordance with the characteristics of a group consisting of predetermined communication service users, the users are connected with the server through their own terminals to share the information or communicate with one another.

Terminals can be connected with the community server through a wired/wireless network to receive community services, and includes computers, PDAs, and mobile terminals that are accessible to the wired/wireless networks.

The predetermined communication service users access the community server through terminals to select their own emotions or conditions among fixed expressions, or to directly input it. Then, the community server displays information about the emotions or conditions input from users on community interface windows so that the users can mutually confirm the other's emotions or conditions.

Since information on the emotions or conditions of respective community members is either input directly, or through fixed expressions, by the community members, there is inconvenience in that such input methods are considered restrictive to the members who are reluctant to directly express their own emotions.

Further, since the respective community members express their own emotions based primarily on the predetermined texts, there is inconvenience in that the users must devote their attention to the contents of the continuously displayed text in order to confirm the emotions or conditions of the respective members.

Therefore, in the conventional art, the function of expressing a user's condition is not active. In addition, since it is difficult for communication service users to know the emotions or conditions of the other members, there is a problem in that it is difficult to strengthen solidarity among the users in a community group and to maintain their friendship due to communications performed without mutually knowing the emotions or conditions of the other members.

Therefore, there is still a need for a method capable of providing opportunities to meet communication service users by expressing the emotions or conditions of the community users indirectly but in detail, and by generating some suitable events in accordance with the emotions or conditions of the users, through the community's common points of interest without individually confirming the emotions or conditions of the community's users.

### SUMMARY

An object of the present invention is to provide a system and method for providing community services wherein emotions or conditions of community members can be indirectly confirmed and opportunities to meet community members can also be provided through suitable events by representing information on the emotions or conditions input from community members or communication service users on a predetermined emotion map in the form of coordinate values and generating suitable events in accordance with coordinate values represented on the emotion map.

Another object of the present invention is to provide a community capable of efficiently communicating emotions or conditions of communication service users with one another, instead of a limited community in which a conventional direct or fixed user condition expression method is employed.

According to an aspect of the present invention for achieving the above objects, there is provided a community service providing system for providing communication services through a wired/wireless network, comprising an input section through which one of emotion and condition information of predetermined communication service users is input, and an emotion/condition analysis module for generating events to provide them with the communication service users by use of the emotion or condition information of the communication service users input through the input section.

Preferably, the system may further comprise an output section for transmitting one of an emotion map processed through the emotion/condition analysis module and information related to the generation of events, to the predetermined communication service users.

According to another aspect of the present invention for achieving the objects, there is provided a community service providing method, comprising the steps of causing one of emotion and condition information of predetermined communication service users to be input, and determining one of a similarity and difference among the communication service users by use of the input emotion or condition information and generating events in accordance with the determination result.

Preferably, the method may further comprise the step of transmitting one of information related to the input emotion information or condition information as predetermined coordinate values and information on generation of the events, to the predetermined communication service users.

### BRIEF DESCRIPTION OF THE DRAWINGS

The above and other objects, advantages and features of the present invention will become apparent from the following description of preferred embodiments given in conjunction with the accompanying drawings, in which:

FIG. 1 schematically shows the configuration and operation of a conventional community service providing system;

FIG. 2 schematically shows the configuration of a community service providing system according to an exemplary embodiment of the present invention;

FIG. 3 schematically shows the operations for providing community services using a terminal, which is a component of the community service providing system, according to an exemplary embodiment of the present invention;

FIG. 4 shows the procedures of processing the operations of the community service providing method according to an exemplary embodiment of the present invention;

FIGS. 5a to 5d schematically show emotion maps according to exemplary embodiments of the present invention; and

FIG. 6 shows locations of members on the emotion map of FIG. 5c according to an exemplary embodiment of the present invention.

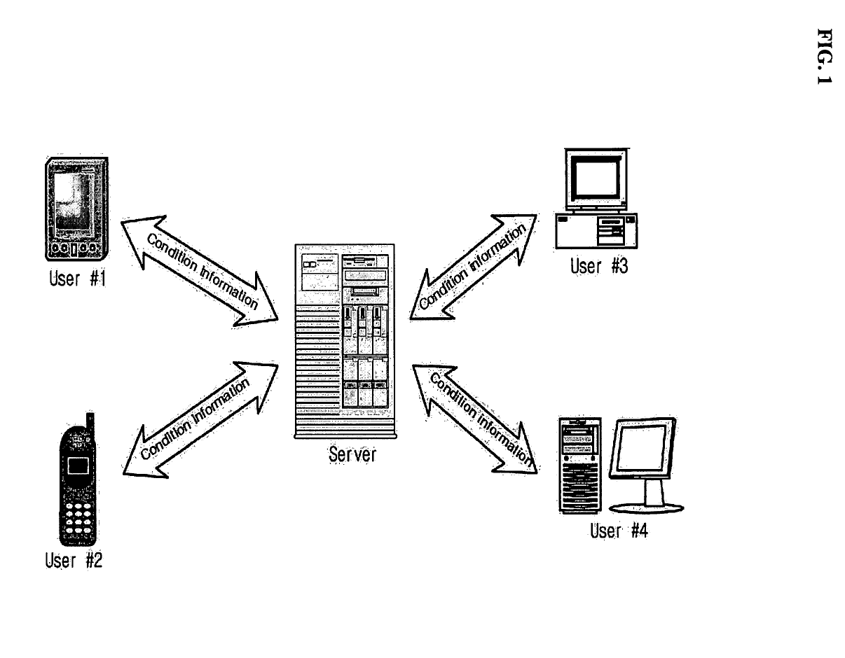

### DESCRIPTION

Hereinafter, the constitution and operation of a community service providing system according to the present invention will be described in detail with reference to the accompanying drawings.

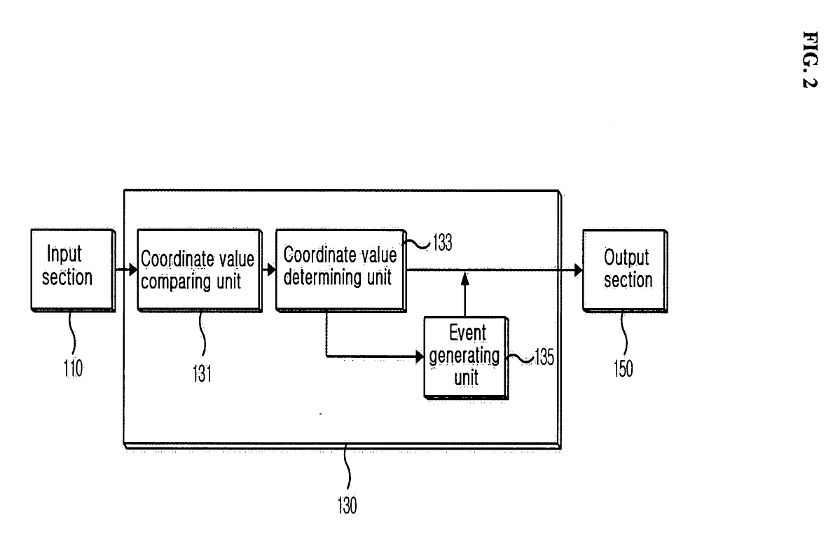

FIG. 2 schematically shows the configuration of a community service providing system according to an exemplary embodiment of the present invention.

Referring to FIG. 2, the community service providing system of the present invention comprises an input section 110, an emotion map (not shown), an emotion/condition analysis module 130, and an output section 150.

The input section 110 receives information on emotions or conditions from predetermined communication service users, and is configured to receive information on current emotions or conditions of the respective users based on information related to coordinate values which move on the emotion map in accordance with key inputs of the users or based on text information corresponding to event types input by the users for requesting a specific event.

The emotion map allows the coordinate values to be represented based on predetermined information axes, and is configured on the basis of one or more information axes used to represent predetermined emotions in accordance with the users.

As an example, when there is a group of communication service users consisting of friends, the emotion map is configured to have four information axes defined as the emotions such as ‘I feel lonely’, ‘Something is not going well’, ‘I want to be alone’, and ‘Everything is going well’.

The emotion/condition analysis module 130 processes the emotion or condition information input into the input section 110 and determines similarities or differences between the users based on the level of concentration and division among the coordinate values represented on the emotion map. Further, the analysis module includes a coordinate value comparing unit 131, a coordinate value determining unit 133, and an event-generating unit 135.

The coordinate value comparing unit 131 measures a proximity degree between the coordinate values based on the coordinate values represented on the emotion map. To this end, the comparing unit calculates relative distances between the coordinate values.

The coordinate value determining unit 133 determines the similarity or difference between the coordinate values within a predetermined range based on the proximity degree between the coordinate values measured by the coordinate value comparing unit 131, determines whether the predetermined events will be generated based on the similarity or difference determination results, and generates a control signal for use in the generation of events.

The similarity or difference is determined in accordance with the level of concentration and division among the coordinate values represented on a coordinate space defined by the information axes configuring the emotion map. The similarity or difference may be determined either by distribution degree of the coordinate values determined in each coordinate space or whether the measured relative distances between the respective coordinate values exceed a predetermined distance range.

For example, since the emotion map according to an exemplary embodiment of the present invention is configured to have four information axes, it has four coordinate spaces. In such a case, the similarity or difference between the communication service users is estimated by determining on which coordinate spaces the coordinate values for representing the emotions or conditions of the users are concentrated, or by estimating whether the measured relative distances between the respective coordinate values exceed a predetermined distance range.

The event-generating unit 135 generates a corresponding event in response to a control signal generated by the coordinate value determining unit 133, and outputs given event messages and sounds.

The output section 150 displays the emotion map in which the coordinate values for representing the emotions or conditions of the communication service users are represented, and indicates or outputs event messages or sounds output from the event-generating unit 135.

The sounds may be properly adjusted in accordance with neighboring environment information (for example, intensity of radiation, and noise level) detected by a sensor provided additionally at the terminal of a user, and may be output in the form of sound effects or vibrations.

In other words, the communication service user can be informed of the generation of events through the vibrations when the user is in a quiet place, whereas the user can be informed via a bell sound when he/she is in a noisy place.

For reference, in the aforementioned community service providing system according to an exemplary embodiment of the present invention, all modules may be configured in hardware, some modules in software, or all modules in software.

Therefore, it will fall within the scope and spirit of the present invention that the community service providing system according to an exemplary embodiment of the present invention may be configured in either hardware or software, and it will also be apparent that various changes and modifications thereof can be made thereto without departing from the scope and spirit of the present invention.

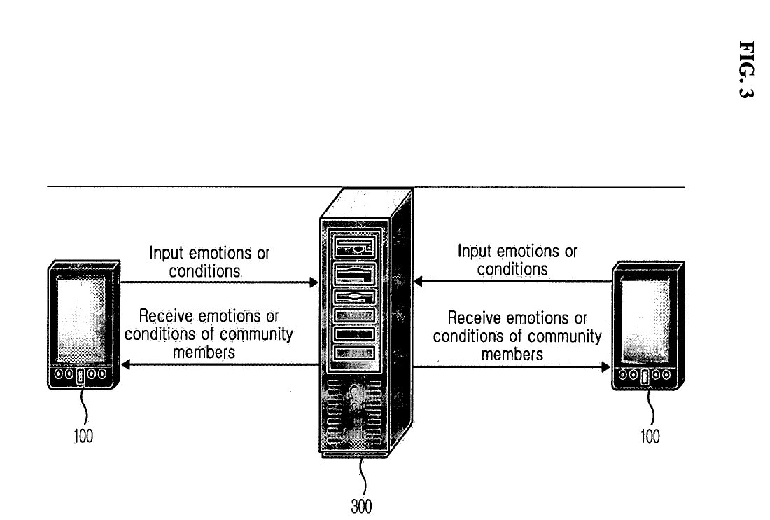

FIG. 3 shows the process of receiving, processing and transmitting the information on the emotions or conditions of the communication service users between the user terminal (for example, a PDA), with the community service providing system integrated therein, and a community server according to an exemplary embodiment of the present invention.

Referring to FIG. 3, a user 100 accesses his/her own community registered in the community server 300 and inputs his/her own emotion or condition information to the server by using the terminal with the community service providing system of the present invention integrated therein.

Then, the user receives the information on the emotions or conditions of other members in the community group from the community server 300 and confirms the emotions or conditions of the community members through the output section 150 in accordance with processing results of the emotion/condition analysis module 130. Then, the user determines whether he/she wishes to participate in the generated events.

A process of transferring the emotions or conditions of the members by using the community service providing system according to the present invention will be described in detail with reference to the accompanying drawings.

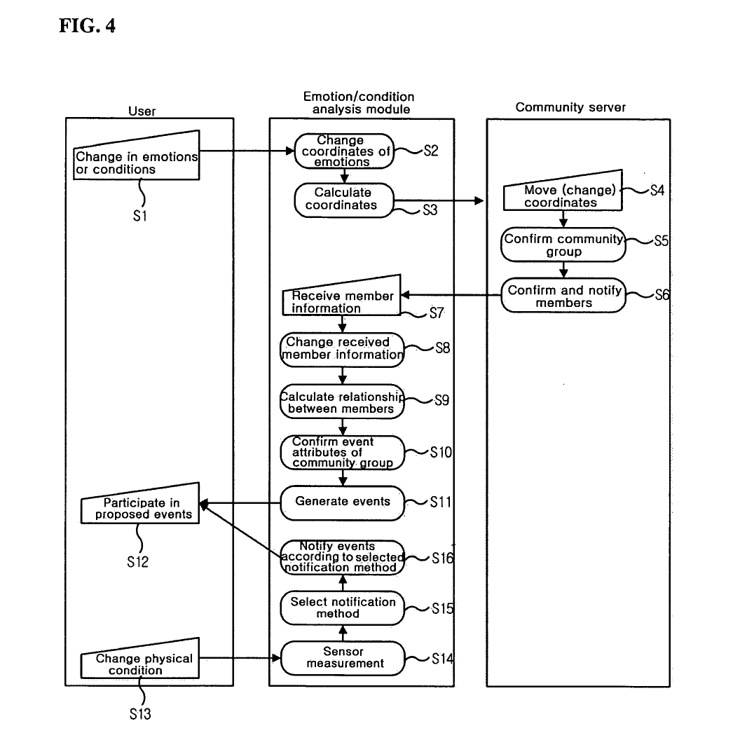

FIG. 4 shows the process of transferring the emotions or conditions of the members in the community service providing system according to the present invention.

Referring to FIG. 4, the user 100 who holds the wired/wireless terminal and is a member of the group consisting of the predetermined communication service users, inputs his/her own emotion or condition to the emotion/condition analysis module 130 through the input section 110 of the terminal when his/her emotion or condition changes (S1).

If a coordinate point on the emotion map provided by the emotion/condition analysis module 130 is changed as the emotion or condition of the user is input (S2), the emotion/condition analysis module 130 calculates the changed coordinate point (S3).

Then, information on the calculated coordinate point is transmitted to the community server 300 to change the information on the emotion or condition of the user 100 (S4). The community server 300 confirms the community group to which the user belongs based on the received emotion or condition information (S5), and reports changes in the emotion or condition of the member to the members in the confirmed community group by transmitting the user's coordinate information on the emotion map to the other members (S6).

Accordingly, the user 100 can receive the coordinate information of members in the group to which the user belongs, which is transmitted from the community server 300 (S7). The emotion/condition analysis module 130 changes the coordinate information of the community users represented on the emotion map in accordance with the received information of the user (S8) upon receipt of the coordinate information.

Thereafter, relationships such as similarities and differences is calculated by comparing the relative distance according to the degree of concentration and division among the users based on the changed coordinate information (S9), and it is determined, based on the calculated difference or similarity result, whether the events are generated (S10).

If it is determined by the coordinate value determining unit 133 of the emotion/condition analysis module 130 that the events are generated, an event attribute of the community group to which the user belongs is confirmed (S10), and the predetermined events are generated through the event generating unit 135 (S11).

The user 100 confirms the events generated through the output section 150 and determines whether to participate in the events by using the input section 110 (S12).

In the process of providing the emotions or conditions of the users, the emotion/condition analysis module 130 detects changes in the user's physical condition through an additional sensor incorporated in the terminal of the user 100 (S13), and measures the neighboring environment information of the user by using this sensor (S14).

A method of reporting events is selected in accordance with the neighboring environment information measured by the sensor (S15), and the user is informed of the generation of events in accordance with the selected event notification method upon occurrence of events (S16).

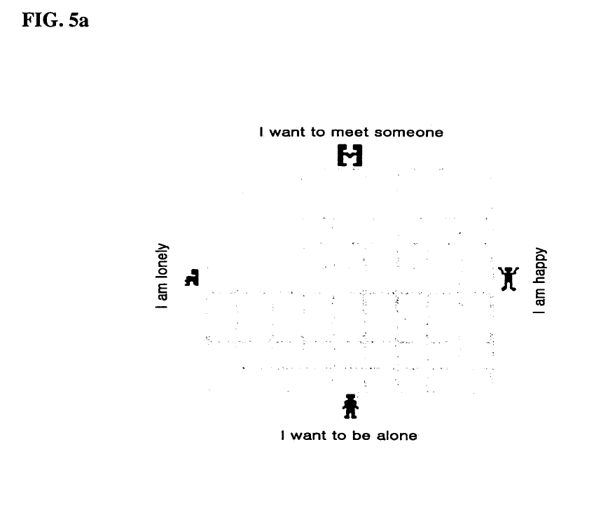

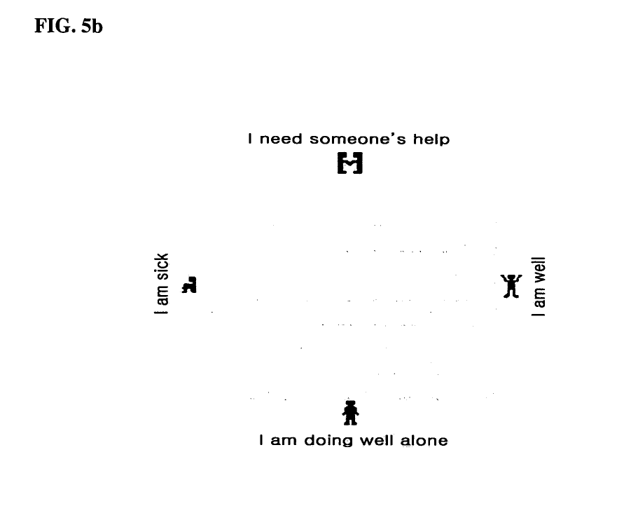

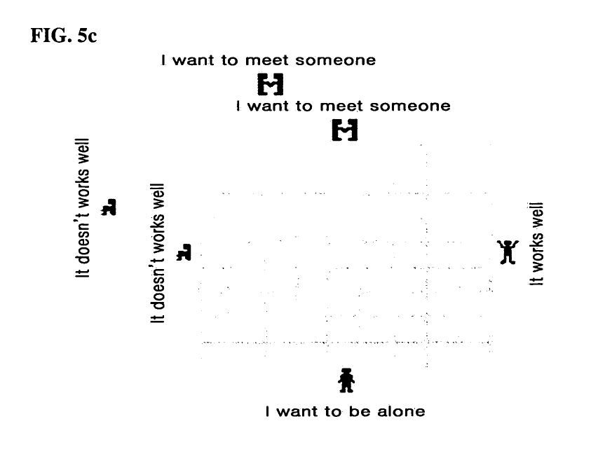

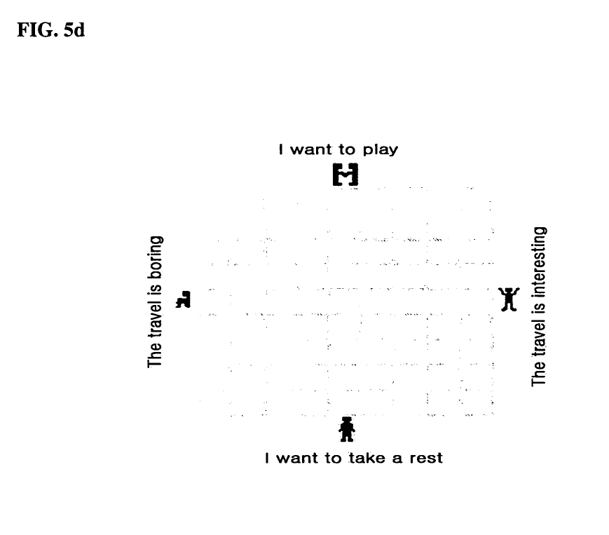

FIGS. 5a to 5d show the emotion maps set for providing the emotions or conditions of users according to the embodiment of the present invention.

Referring to FIGS. 5a to 5d, the emotion maps are prepared or defined by the information axes determined by the respective communication service user groups. FIG. 5a shows an emotion map of a group consisting of sweethearts. FIG. 5b shows an emotion map of a group consisting of family.

Further, FIG. 5c shows an emotion map of a group consisting of friends, and FIG. 5d shows an emotion map of a group consisting of tourists.

As an example, the terminal user belonging to the group of the emotion map shown in FIG. 5c receives the emotion map as shown in FIG. 5c from the emotion/condition analysis module of the community service providing system.

The user inputs his/her own current emotion or condition by using the emotion map. That is, the user personally moves his/her own icon onto the emotion map displayed on the output section 150 of the terminal or inputs a desired event selected from the events that are already set for the registered groups.

If the user inputs the key, the coordinate value comparing unit 131 of the emotion/condition analysis module 130 transmits the coordinate value of the icon, moving on the emotion map in accordance with the key input, to the community server 300, which in turn collects information on the moved coordinates for members of the group to which the user belongs and transmits the collected information to the other members of the group, so that the change in coordinate points of the users in the relevant group on the emotion map can be reported.

The emotion/condition analysis module 130 that receives the location information of the users transmitted from the community server changes the locations of the respective members on the emotion map in accordance with the received location information.

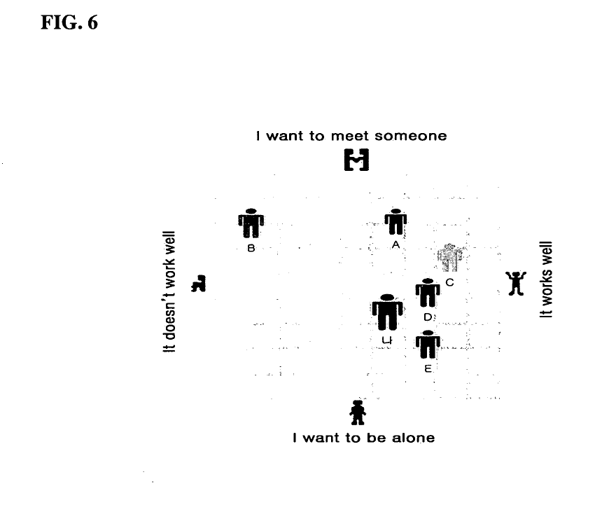

If the locations of the members in a community group are changed as shown in FIG. 6, the coordinate value comparing unit 131 of the emotion/condition analysis module 130 calculates the location and distance relationship between the respective users in accordance with the changed location information.

The coordinate value determining unit 133 determines the similarity or difference between the users based on the relationship between the respective users calculated by the coordinate value comparing unit 131. As shown in FIG. 6, since only a communication service user B is far apart from the other users, it is determined that the user B represents a difference user.

As a result of determining that user B is different with respect to the other users on the emotion map, the coordinate value determining unit 133 generates the control signal for generating the predetermined events such as reporting the emotion or condition of the user B to the other users or transferring the message for the user B.

The event-generating unit 135 outputs the corresponding events to the output section 150 in response to the control signal from the coordinate value determining unit 133.

As a result, a meeting for the user B is held based on the participation of the communication service users or a message for comforting the user B is automatically sent out to the user B, so that the emotions or conditions of the communication service users can be shared with one another.

Furthermore, according to another preferred embodiment of the present invention, the community service is provided through the community server with the community service providing system of the present invention incorporated therein.

That is, the user registered in the predetermined community group accesses the community server by using the terminal and inputs his/her own emotion or condition to the server through the input section 110 of the terminal.

The emotion or condition information input by the user is transmitted to the emotion/condition analysis module 130 of the system of the present invention, which is included in the community server. The emotion/condition analysis module 130 collects the emotion or condition information received from the respective members and obtains the corresponding coordinate values on the emotion map.

The emotion or condition information of the respective users is transmitted to the other users based on the coordinate values obtained as such, and the coordinate value comparing unit 131 of the emotion/condition analysis module calculates the relationship between the respective users based on changes in the coordinate values due to the emotional change in the respective users and determines the similarity or difference between the communication service users.

The coordinate value determining unit 133 determines whether the predetermined events corresponding to the characteristic of the group are generated in accordance with the result of determining the similarity or difference between the communication service users. If it is determined by the coordinate value determining unit 133 that the events have been generated, the event-generating unit 135 informs the respective users of events generated.

Accordingly, the specific user can confirm the emotion or condition of the other communication service users and can share emotions or conditions with the other users.

According to the present invention, there are advantages in that the communication service users can indirectly confirm their emotions or conditions with one another and their unity can be promoted through the events generated in accordance with the similarity or difference between the users.

Although the present invention has been described in connection with the preferred embodiments of the community service providing system and method shown in the accompanying drawings, it is a mere example of the present invention. It can also be understood by those skilled in the art that various changes and modifications can be made thereto without departing from the scope and spirit of the present invention defined by the claims. Therefore, the true scope of the present invention should be defined by the technical spirit of the appended claims.

1. A community service providing system for providing communication services through a wired/wireless network, comprising:
an input section through which one of emotion and condition information of communication service users is input; and
an emotion/condition analysis module for generating events to provide to the communication service users by use of said one of the emotion and condition information of the communication service users, input through the input section.

2. The system as claimed in claim 1, further comprising an output section for transmitting one of an emotion map processed through the emotion/condition analysis module and information related to the generation of events to the communication service users.

3. The system as claimed in claim 1, wherein the input section maps said one of the emotion and condition information of the communication service users into an emotion map.

4. The system as claimed in claim 3, wherein the emotion map allows one of a user's emotion and condition information to be represented as coordinate values based on predetermined information axes to indicate a predetermined emotion defined by the communication service users.

5. The system as claimed in claim 4, wherein the emotion/condition analysis module comprises:
a coordinate value comparing unit for measuring a proximity degree of the coordinate values represented on the emotion map, corresponding to said one of the emotion and condition information of the communication service users input through the input section;
a coordinate value determining unit for determining at least one of a similarity and a difference between said coordinate values within a predetermined range based on the proximity degree measured by the coordinate value comparing unit; and
an event generating unit for generating corresponding events in response to a control signal generated by the coordinate value determining unit.

6. The system as claimed in claim 5, wherein said at least one of the similarity and difference is determined using one of the proximity degree and relative distance between the coordinate values measured by the coordinate value comparing unit.

7. The system as claimed in claim 5, wherein the events are determined according to said at least one of the similarity and the difference represented by the communication service users, and the events are determined based on the coordinate values indicated on the emotion map.

8. A community service providing method, comprising the steps of causing one of emotion and condition information of communication service users to be input, and determining one of a similarity and difference among the communication service users by use of said one of the input emotion and condition information, and generating events in accordance with the determination result.

9. The method as claimed in claim 8, further comprising the step of transmitting one of information on the input emotion and condition information as predetermined coordinate values and information on generation of the events, to the predetermined communication service users.

10. The method as claimed in claim 8, wherein the step of generating the events comprises a step of generating events specified previously in accordance with an attribute of a group to which the communication service users belong.

11. The method as claimed in claim 8, wherein the step of generating the events comprises a step of selecting an event notification method in accordance with neighboring environment information measured by a sensor provided in a terminal of each of the communication service users.

12. The method as claimed in claim 8, wherein said one of the emotion and condition information is information related to coordinates, which move on the emotion map in accordance with a key input by at least one of the communication service users.

13. The method as claimed in claim 8, wherein said one of the emotion and condition information is text information corresponding to at least one type of event required by at least one of the communication service users.

14. The method as claimed in claim 8, wherein said one of the similarity and difference is determined using one of a proximity degree and a relative distance for coordinate values, which are measured based on the coordinate values represented on an emotion map, corresponding to said one of the input emotion and condition information of the communication service users.

15. The method as claimed in claim 8, wherein an emotion map is configured based on predetermined information axes indicating predetermined emotions defined by the communication service users, so as to represent one of emotions and conditions as coordinate values.
